(19) United States
(12) Patent Application Publication
(10) Pub. No.: US 2002/0032623 A1
(43) Pub. Date: Mar. 14, 2002

(54) Method and apparatus for mail management

(76) Inventors: William Wheeler, San Springs, OK (US); Dennis L. Kenbeek, Broken Arrow, OK (US); Duane Cooper, Rome, PA (US); Theresa Bennett, Endicott, NY (US); William Terry, Barton, NY (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/825,450

(22) Filed: Apr. 3, 2001

Related U.S. Application Data
(60) Provisional application No. 60/193,821, filed on Mar. 31, 2000.

(51) Int. Cl. G06F 17/60

(52) U.S. Cl. 705/28

(57) ABSTRACT

A method and apparatus are provided to facilitate the management, handling and tracking of interoffice and other mail items by permitting the tagging of each such item and the recording of the mail item in a computer system. Tags on the mail items may be used to track the items through a mail system, the records preferably being updated as the mail item is tracked through the system, and the item records may be queried to determine the status of an item and for other purposes.

This application claims priority to Provisional Application No. 60/193,821 and incorporates it by reference.

### FIELD OF THE INVENTION

The present invention relates to methods and apparatus for managing and performing other functions relative to mail items, and more specifically to a computer system and associated methods for computerized tracking and managing of interoffice mail items.

### BACKGROUND OF THE INVENTION

Handling and distribution of physical paper, materials, supplies and other interoffice mail items remains a vital internal link in running a business. In addition to sending each other letters and packages of various sizes, workers receive items from and send items to destinations outside the company, request supplies from supply rooms and labs, exchange models and visual aids, and in general rely on interoffice mail systems to send and receive all matter of items, and not just those usually referenced to as mail. The terms “interoffice mail,” “mail items” and “items” as used in this application will, therefore, generally refer to all such interoffice items and item transfers.

Many aspects of mail room operations have not changed from pre-digital days. Mail is most often sent in what is commonly referred to as “holy joe envelopes,” which have a number of address blocks on one or both sides and punched holes through which the presence of something in the envelope can be determined. These envelopes have to be manually processed to determine which box on which side of the envelope contains the current address. Often, only a recipient name or part thereof is indicated, requiring further human attention as mail room personnel look up possible addressee name completions and office locations. This task is further complicated where two or more individuals in a company or office have the same name parts or initials, sometimes making unique identification of a mail recipient virtually impossible. High speed recognition of handwritten and typed addresses on the items is not generally available. Tracking or interactive managing of items in transit is also not possible in these existing systems.

A need therefore exists for a system which combines the physical reality of picking up, sorting, and delivering mail items with computer interface providing users and operators a user friendly interface for filtering, queuing, managing, mapping, tracking, and redirecting mail items. The system should deal with all manner of items, not only those traditionally sent in holy joe envelopes, and should also manage and track outgoing and incoming off-site mail items. In addition, such a system should function with and easily integrate with the offices existing mail delivery, electronic mail and computer infrastructure.

### SUMMARY OF THE INVENTION

In accordance with the above, this invention provides a method and apparatus for managing the movement of interoffice and other mail items, generally referred to hereinafter as items. In one aspect, the method involves entering each item to be sent into a computer system, with each of the items having a tag. The system generates and stores a record for each item and the tag for each item is utilized at selected points in the transport of the item to control the transport. The system queries the record for an item and responds to a query concerning the item from an authorized system user to determine a response to the query and provides the response to the user. The system may operate in response to the entering of an item to generate a tag to be affixed to the item. The tag may include an item ID which is machine-readable and/or human readable, the machine-readable item ID being in bar code for an illustrative embodiment. The record for an item may be updated as the item reaches at least selected points in the transport, the system utilizing the updated record to respond to a query as to the current status of the item.

The query may for example be from an item sender as to all items the sender has sent over a selected time period or a query from an item recipient as to all items sent to the recipient over a selected time period, the system looking at appropriate fields of item records to respond to such queries. The senders of items may include both entities within the office organization and entities outside the office organization, the sender entering the items into the system for entities within the organization and a mail room person entering the items into the system for entities outside the organization.

An electronic message is preferably automatically sent to at least one entity when an item is entered into the system, the electronic message being an e-mail message for preferred embodiments. The electronic message may for example be sent to an office mail room. Each office entity may establish preferences, including that the entity is to receive an electronic message when an item is entered into the system on which the entity is a recipient, the system sending an electronic message to an entity establishing such preference each time the entity is the recipient of an entered item.

The system stores preferences entered into the system by office entities and utilizes the preferences to control selected operations involving the entity. The preferences may for example include selected information on the entity, the information being automatically entered into appropriate fields of a record for an item on which the entity is the sender and/or recipient. The preferences may also include selected conditions under the which the entity is to receive messages concerning an item on which the entity is the sender and/or the recipient, the system sending a status message to the entity when the preference conditions are satisfied. The selected conditions may include the item reaching at least one selected point in an item transport and the nature of the item being transported. A user can also store as preferences a proxy address and/or a forwarding address for at least selected mail items, the system routing such a selected mail item with the user as a recipient to the appropriate proxy or forwarding address.

The system may have access to current addresses of office users, for example from the office directory. When a mail item is received with an address, for example a mail item from outside the office, the system may check the address provided on the mail item for the user against the current address for the user and send the item to the current address even if different from the address on the mail item. Where the office is part of an organization having at least one directory of entities within the organization, the system may utilize such directory in generating the records and/or the tags. An ordering entity at one office location can enter an order for an item to be shipped to the ordering entity by a sending entity at a second location, the order causing a tag for the item to be generated at the second location for use in sending the item to the ordering entity. In such case, the system preferably generates a record for the item and updates the record as the item is shipped, the system utilizing the updated record for the item to respond to a query from the ordering party concerning the order. For one embodiment, the system sends an electronic message to the item sender and/or the item recipient when the item is delivered to the recipient.

Where each item has a tag with an ID code which is both human-readable and machine-readable, if an item received at an office mail room is detected as not having an ID code in both forms, the system may determine the ID code for the item and add the ID code to the item in the form which is missing. When an item reaches an office mail room, the tag on the item is read and any information on the tag which is not in the record for the item may be added to the record.

Where some of the items are to be sent to entities outside the office by a carrier having its own tags and ID codes, the record for an item is utilized in conjunction with carrier software to generate a carrier tag with a carrier ID. During the entering step, the sender designating the carrier to be used for the item may cause a tag to be generated for the item which tag is a carrier tag having a carrier ID code, or the carrier tag with the carrier ID may be generated at the office mail room and attached to the item. The system may also utilize the records to generate reports in response to requests for such reports from selected authorized system users.

The invention in accordance with another aspect includes a method for users of a mail system to selectively track movement of items through the system which includes each user entering preferences into the system as to selected conditions under which the user is to receive electronic messages concerning an item on which the user is a sender and/or a recipient, the system tracking movement of items through the system, and the system sending an electronic status message to the user if one of the user preference conditions is detected as being satisfied. The sender and/or the recipient of an item may be automatically sent an electronic status message when the item is delivered. A mail item recipient may also query -the system for all items that have been sent to the recipient over a specified time interval, the system providing an electronic message to the recipient containing relevant mail items in response to such query; or a mail item sender may query the system for all items that have been sent by the sender over a specified time interval, the system providing an electronic message to the sender containing relevant mail items in response to such query.

In accordance with still another aspect of the invention, a system for managing the movement of interoffice items is provided which includes a plurality of terminals at which a sender enters into the system an item to be sent and/or a query to the system; a first mechanism operative in response to an item being entered for generating a tag to be affixed to the item; a second mechanism operative in response to an item being entered into the system for generating and storing a record for the item; a third mechanism operative at selected points in transport of an item in response to the tag for the item to control the transport; and a fourth mechanism by which the system utilizing the record for an item obtains a response to a query from an authorized system user relating to the item and provides a response to the user. The first mechanism preferably generates on each of the tags an item ID which is machinereadable and/or human-readable, the ID machine-readable form being printed on the tag in bar code for an illustrative embodiment. The second mechanism is preferably operative to update the record for an item as the item reaches at least certain points in the transport. The fourth mechanism preferably uses the updated record for an item to respond to a query concerning the status for the item. The system may receive a query from an item sender as to all items the sender has sent over a selected period and/or a query from an item recipient as to all items sent to the recipient over a selected period, the fourth mechanism looking at appropriate fields of item records to respond to such queries.?

A fifth mechanism may be provided for selectively sending electronic messages to system users in response to the detection of selected events with respect to an item, the message being an e-mail message for illustrative embodiments. The fifth mechanism may send an electronic message to at least one of the item sender and the item recipient when the item is delivered to the recipient.

A sixth mechanism may be provided which facilitates the entry by system users of selected preferences, the storage of the preferences and the utilizing of the preferences to control selected operations of the system, which operations involve the user. The preferences may include selected information on the user, the second mechanism automatically entering the information into appropriate fields of a record for which the user is the sender and/or the recipient. The preferences may also include selected conditions under which the user is to receive messages concerning an item on which the user is the sender and/or the recipient, the fifth mechanism sending a status message to the entity when preference conditions are satisfied, such conditions including for example the item reaching at least one selected point in an item transport and/or the nature of the item being transported.

The office may be part of an organization having at least one directory of entities within the organization and the first mechanism and/or the second mechanism may utilize such directory in generating the records and/or tags respectively.

Finally the invention may include apparatus which permits users of a mail system which tracks movement of items through the system to determine the movement status of selected items, the apparatus including terminals at which a user can enter into the apparatus preferences as to selected conditions under which the user is to receive electronic messages concerning an item on which the user is a sender and/or a recipient, a memory storing the preferences and a mechanism which sends an electronic status message to the user when one of the user preference conditions is detected as being satisfied. The mechanism may automatically send an electronic status message to the sender and/or the recipient when an item is delivered. A mail item recipient may also query the system for all items that have been sent to the recipient over a specified time interval, the mechanism providing an electronic message to the recipient containing relevant mail items in response to such query; or the mail item sender may query the system for all items that have been sent by the sender over a specified time interval, and the mechanism may provide an electronic message to the sender containing relevant mail items in response to such query.

The foregoing and other objects, features and advantages of the invention will be apparent from the following more particular description an illustrative embodiment of the invention as illustrated in the accompanying drawings, the same or like reference numerals being used for like elements in the various drawings.

### BRIEF DESCRIPTION OF THE FIGURES

FIG. 1 is a diagram of the illustrative embodiment.

FIG. 2 is a diagram of components of the illustrative embodiment.

FIG. 3 is picture of a mail item coversheet

FIG. 4A is a flow diagram of user software.

FIG. 4B is a flow diagram of mail center software.

FIG. 5 is a flow diagram of a “Create New Item” function.

FIG. 6 is a flow diagram of submitting mail item information.

FIG. 7 is a flow diagram of a “Status/Withdraw Mail Items” function.

FIG. 8 is a flow diagram of a “Change Preferences” function.

FIG. 9 is a flow diagram of checking notification preferences.

FIG. 10 is a flow diagram of receiving a mail item from outside.

### DETAILED DESCRIPTION OF THE INVENTION

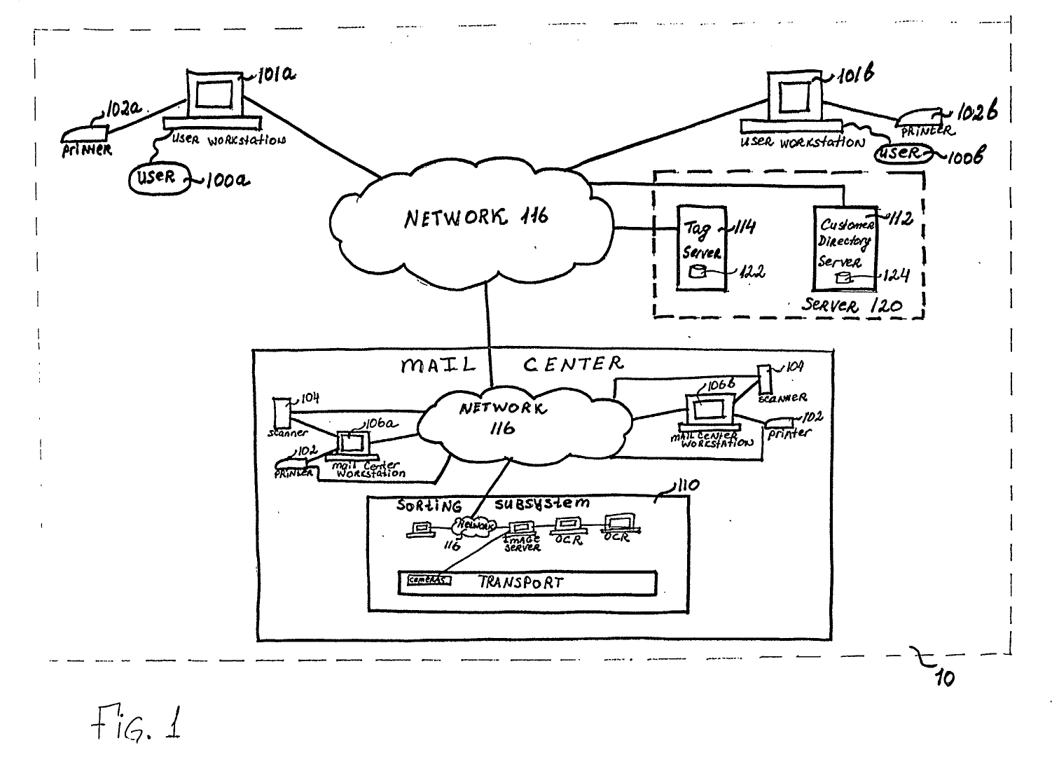

Referring to FIG. 1, a schematic representation is shown of an illustrative embodiment 10 for a system in accordance with a teachings of this invention, as it would look when installed on a customer site. The actual configuration of the system will vary from customer to customer, as the system is adapted to a customer needs and existing infrastructure. A customer may be a company or an organization which has an existing interoffice mail system or is looking to set one up. A customer can also be a set of organizations sharing address databases. System 10 typically runs at a single large campus site as depicted, but can also be configured to simultaneously support several sites, or even several related or unrelated organizations. While system 10 is primarily directed to interoffice mail applications, it is not limited to such applications and may be deployed as a managing and tracking system for other mail applications and environments.

System 10 includes a plurality of user workstations 101a, 101b-101n networked through network 116, as well as mail center workstations 106a, 106b-106n located in one or more customer mail centers or mail rooms and also connected to the network 116. In addition to the workstations, there is a server 120 storing data and responding to queries as described below. Each workstation 101 is connected to a corresponding printer 102 and may also be connected to a corresponding scanner 104. Workstations 106 in a mail center may be connected to corresponding scanners 104 and printers 102. Users 100a-100n use user workstations 101 to connect to system 10 and to send and track interoffice mail items, as well as to perform other daily functions. Typically, the configuration of user workstations 101, network 116 and mail center workstations 106 is already in existence at the customer site. A sorting subsystem 110 is also located as part of the mail system.

Each user 100 generates mail items to be sent to other users and drops them off at the nearest drop-off station (not shown), or otherwise arranges for the items to be picked up by mail center personnel, generally in accordance with existing organization procedures. Picked up items are delivered to the mail center, sorted in the sorting subsystem 110, dropped in delivery bins (not shown), and delivered to intended end user 100 recipients.

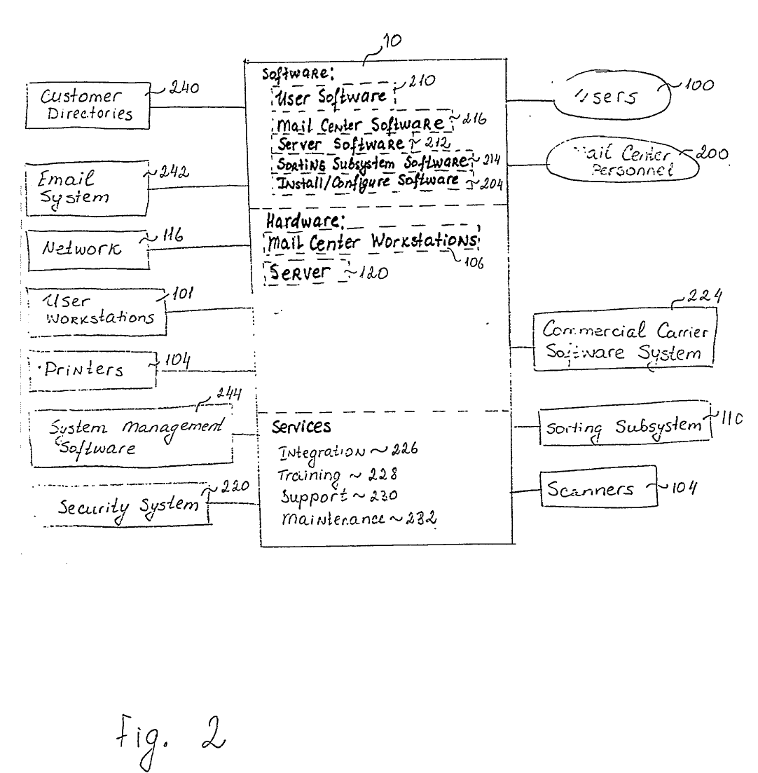

System 10 provides information management functions for end users 100 and mail center personnel 200 (FIG. 2) to monitor the progress of sent mail items and automation for mail processing; it is also intended to exploit standard, commercially available computing and communications equipment and network 116.

System functions are implemented in software using the client/server paradigm where end user workstations run user software 210 (FIG. 2), mail center workstations 106 run mail center user software 216 (FIG. 2), and server and management workstations 112 and 114 run system server software 212 (FIG. 2). Server and management workstations 112 and 114 together comprise system server 120. Server 120 is a collective term used to refer to any number of single or multiple-processor machines hosting system server software 212. The machines forming system server 120 can be arranged and configured to provide redundancy in case of failures.

All communications between software on different computers take place over network 116 which includes any local area networks, wide area networks, and any other communication systems and networks present on the customer site.

In addition to the above described components, customer site computer systems generally support an email system 242 (FIG. 2). Present on the customer site there are also customer directories 240 (FIG. 2). Customer directories 240 contain information about customer addresses and their preferences, as will be described below.

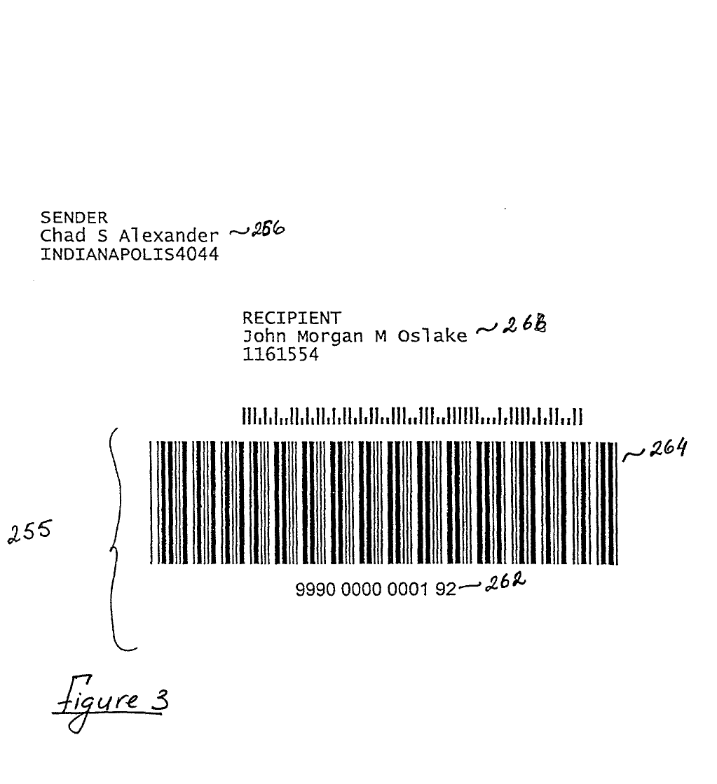

User 100 uses system 10 to send and receive mail items. When in transit, a mail item 250 has a label 260 affixed to it, as shown in FIG. 3. A label may be an actual stick-on label or a cover sheet printed and temporarily attached to the mail item. A label contains an ID 262, a bar code, 264, a sender address 266, and recipient address 268. The ID 262 and bar code 264 together comprise a unique tag 255. The ID 262 is a human-readable version of the bar code 264. Parts of ID 262 and Barcode 264 may be used to encode a specific site if customer has multiple sites or a specific organization if customer is a set of organizations. Barcode 262 is scanned at various points of transit and status of the mail item is updated in system 10 according to the scanning location. Sorting subsystem 110 also can use barcodes in order to sort the item. Items are sorted according to a predefined sort plan. As subsystem 110 scans the barcode 262 of a particular item, it requests the recipient information for that item from server 120 and sorts the item based on the recipient address.

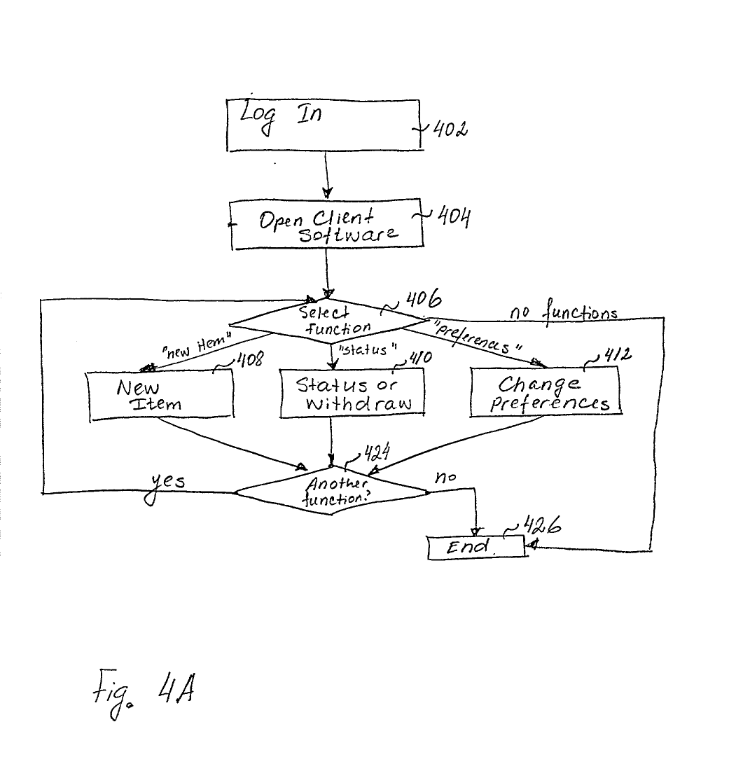

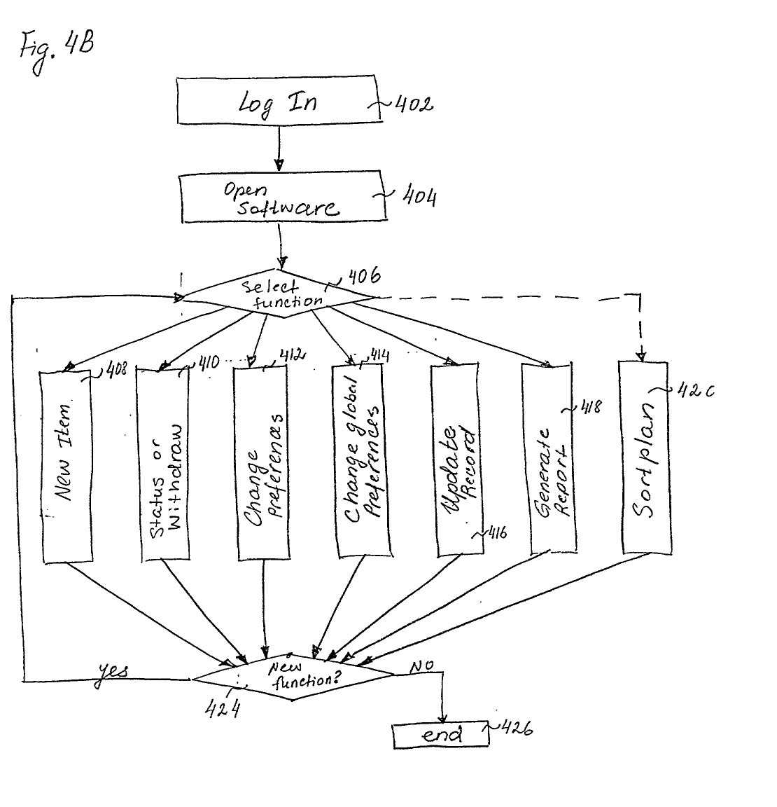

The operation of the system 10 will now be described in further detail. Users 100 and mail center personnel 200 use user client software 210 and mail center client software 216, respectively, to interact with the system. FIGS. 4A and 4B show basic steps involved in operating client software.

FIG. 4A is a flow diagram of user interaction with the client software 210. To be able to use the system 10, user 100 has to first log into his computer 101. Client computers 101 typically have a standard operating system installed. This operating system allows user to perform his daily functions and provides means for networking and, in particular, for sending and receiving of email using standard email software 242. The operating system typically also has an authentication mechanism 220 through which the user authenticates himself to the system. System 10 uses this initial authentication to the customer system as authentication for the system 10. In the illustrative embodiment, authentication is done through password exchange. When user 100 logs into the customer system in step 402, he presents his user name and password. Once the system determines that the password is correct, the user is logged in and able to run any software installed on his workstation 101. Alternatively, security can be implemented using any standard authentication measures on the operating system or as part of system 10 itself.

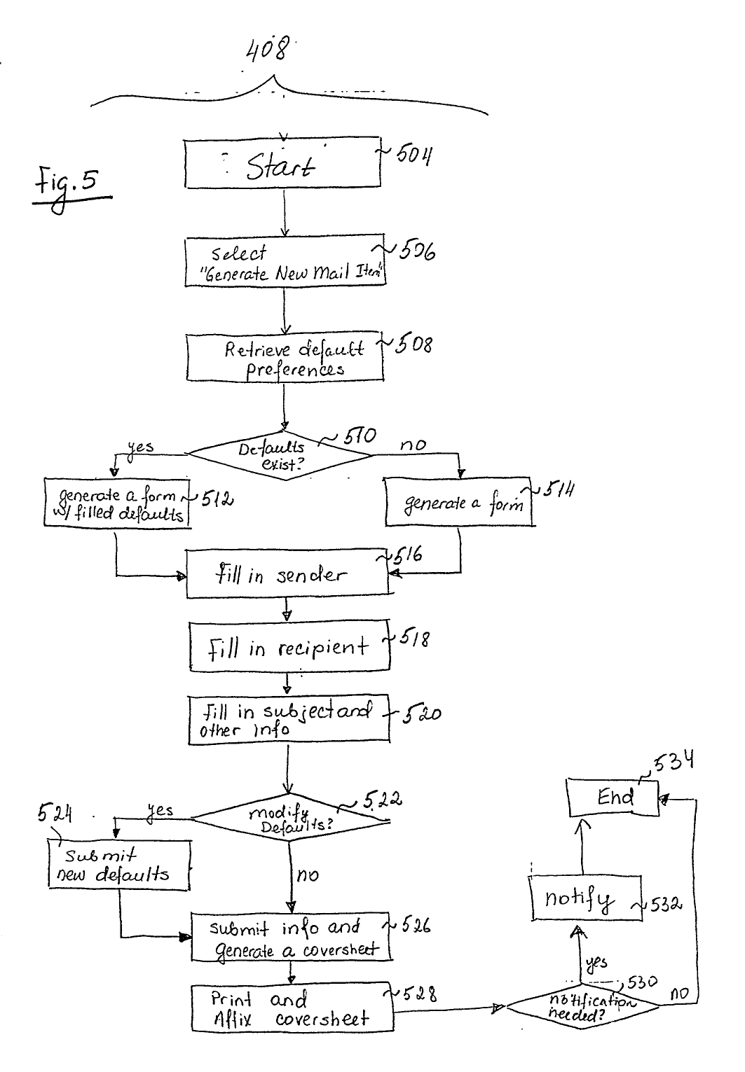

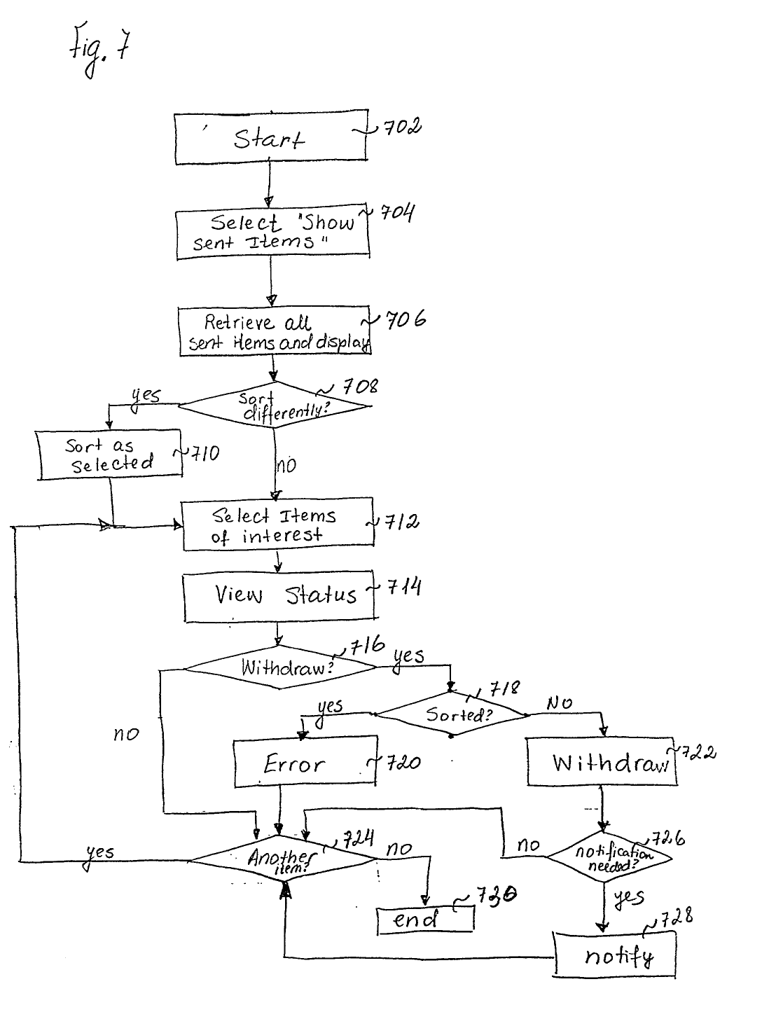

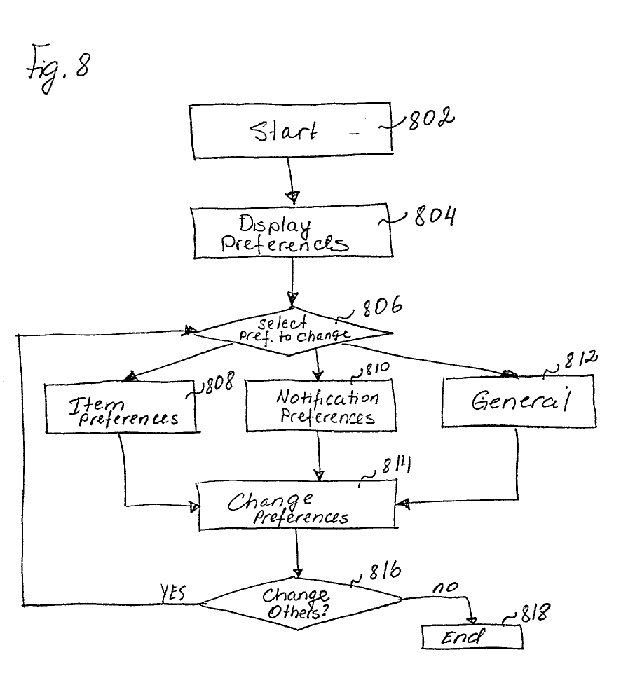

Once the user is logged in, he opens user software 210 in step 404. In the illustrative embodiment, user software is a plug-in for the email software, but it can be implemented as stand-alone software. User software 210 can perform a number of functions, and the user selects a function he needs in step 406. The main functions of user software 210 are: creating a new mail item in step 408 (FIG. 5), checking status of or withdrawing a sent mail item in step 410 (FIG. 7) and changing preferences in step 412 (FIG. 8). When the user 100 is done using the function he selected, he can proceed to use other functions through step 424 back to step 406 or finish using user software 210 in step 426.

FIG. 5 is a flow diagram of steps performed by user 100 and system 10 when a new mail item is to be created in step 408 (FIG. 4). The user starts by selecting “Generate New Mail Item” function (step 506) from the menu in the user client software 210.

Associated with each user, there is a set of user preferences stored on the server 112 in user preferences database 124. When the “Generate New Mail Items” function is selected, system 10 retrieves default user preferences from server 112 (step 508). Preferences can include a default sender, default recipient, default subject of the email or other default information about the mail item.

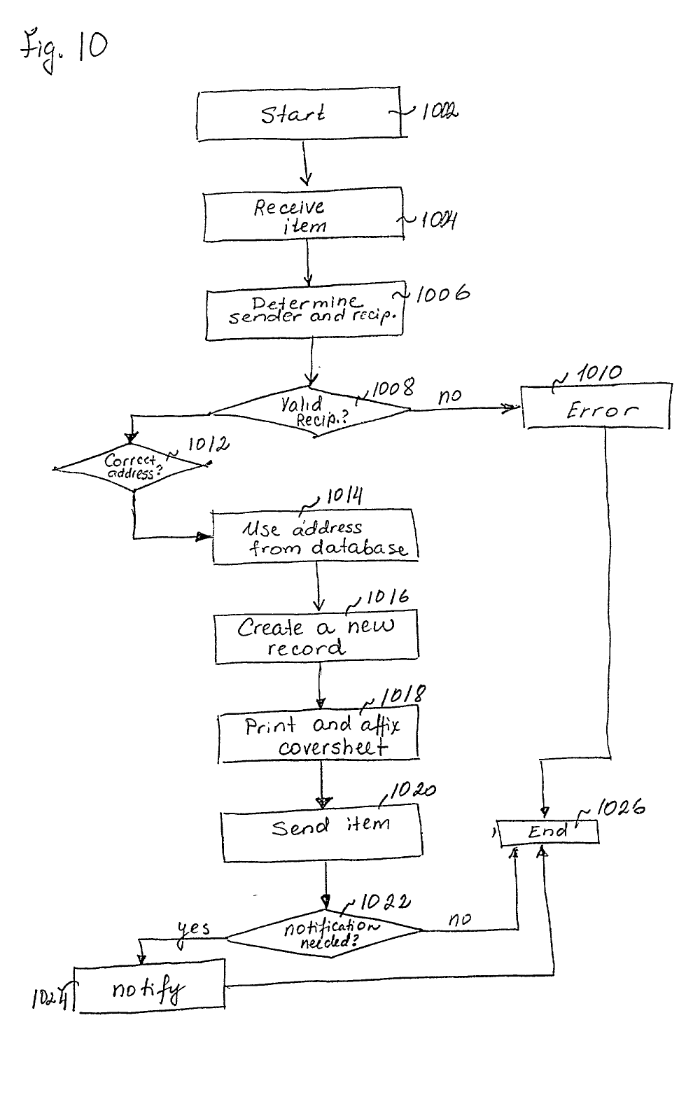

User software 210 checks for existence of default settings pertinent to creating a new mail item in step 510. If such defaults exist, user software 210 prepares a new mail item form with default settings already filled in (step 512). For example, the “sender” field will most often be automatically filled in by the user software 210, the sender identity generally being identical to the identity of the user 100 using the user software 210. However, it is possible that the user and the sender identities will differ if, for example, a secretary is creating a new mail item to be sent from his supervisor, or a mail center user is creating a new mail item to be sent internally that was originally a package coming from outside (FIG. 10).

If there are no default settings, the user software 210 prepares a new mail item form with blank fields. The user then fills in the sender and recipient information in steps 516 and 518. Even if that information was already filled in from default settings, the user is given an option of changing them if the current sender and recipient information does not correspond to the defaults.

The user then fills in any additional information about the mail item, such as subject and other information. Other information can include an urgency indicator, size of the mail item, comments about state or status of the mail item, special care instructions or other information. For example, for an outgoing mail item, the user can indicate which outside commercial carrier system should be used. When such item reaches the mail center, it will be sent to its final destination using the selected commercial carrier. The information about the selected carrier's tracking number for the mail item can then be also entered into the “other information” part of the record by mail center personnel, or, with a suitable link between user software 210 and carrier software, the carrier tracking number may be entered by the user. Or a mail item can be a set of other mail items taken together, and the “other information” field can contain a listing of individual mail item records for all mail items contained there. If a mail item is being ordered from a supply room or other place supporting orders, “other information” fields can contain price or descriptions of the ordered items. In general, this field can be tailored to the individual customer needs and can be adapted to a wide variety of uses.

Once all the information is filled in, the user can select to modify defaults to match the current mail item information (step 522). If the user selects to do so, user client software 210 submits the new defaults (step 524) to customer directory server 120 (FIG. 1), where they are recorded in the customer preferences database (not shown) to be retrieved the next time when the user elects to create a new mail item.

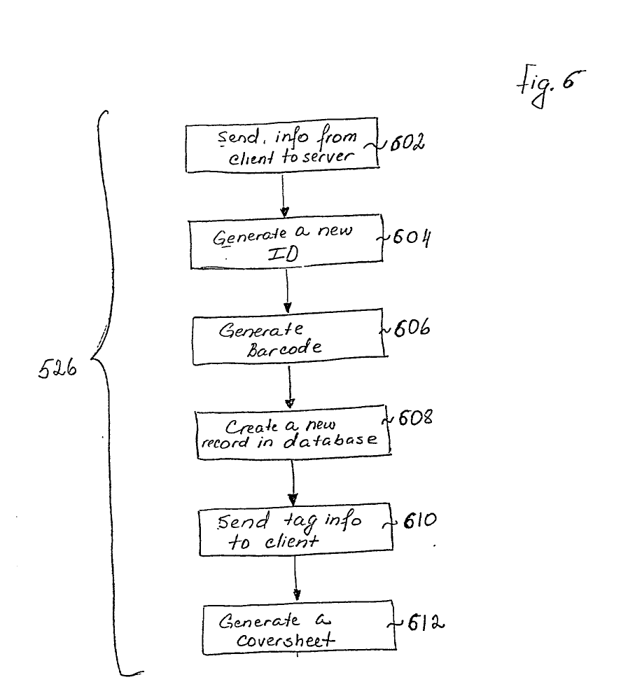

If the user does not want to set new defaults or after submitting new defaults to the server, the user client software 210 submits information about the new mail item to the Tag Server 114 (FIG. 1) in step 526. The tag server responds and, based on the response, the user software 210 generates a coversheet for the new mail item. FIG. 6 shows step 526 in further detail. All information from the new mail item form is submitted from the user software 210 to the tag server 114 (FIG. 1) in step 602. Based on the information received and additional settings in the server software 212, the tag server 114 generates a new Identification Number (ID) for the new mail item (step 604). Either simultaneously or after generating the ID, the tag server 114 generates a barcode 262 for the new mail item (step 606). The ID and barcode are correlated to refer to the same item.

Alternatively, user 100 may be generating a new record or updated record for a mail item that already has a coversheet. In that case, mail item ID can be entered as part of “other information fields” and also submitted to the server, where it is used to create a new record or update an old one, if it exists.

Using the information about the mail item and the generated tag, which consists of the ID and the barcode, the tag server 114 creates a new item record (step 608) and stores it in the item database 122 (FIG. 7). This record will be updated as the item moves through the system 10.

When the item database is updated to contain the new record, the tag for the new mail item is sent back to the user software 210 over network 116 (FIG. 1). The user client software 210 generates the coversheet for the new mail item, the coversheet containing sender and recipient addresses 266 and 268, respectively, bar code 264, and ID 262 (FIG. 3).

The user can view and print out the coversheet (FIG. 5, step 528). The coversheet can be printed out on standard paper and for example folded and fitted in a transparent pocket on the mail item or on special labels to be attached to the mail item. The user affixes the coversheet or the label to the mail item in step 528 and can proceed to drop off the mail item at the nearest inter-office pickup station.

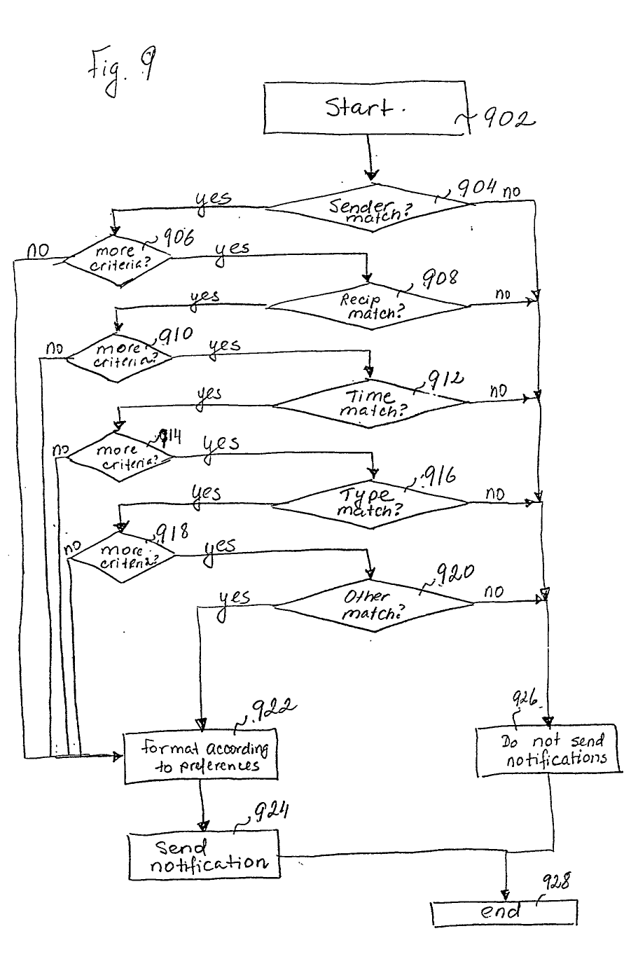

Meanwhile, the system 10 has to decide whether notifications have to be sent out to anyone because of the creation of this new mail item (step 530). Such notifications could for example be standard notifications built into the user software, for example notifications to the customer mailroom, or could be based on user preferences in the system, for example notification preferences of the sender or recipient. If creation of the new mail item triggered any settings in step 530, notifications are sent out in step 532. FIG. 9 describes the notification process in further detail. Once any needed notifications are sent, sending of the new mail item is complete and the user can proceed to any other functions available (FIG. 4, step 406).

Another function available to user 100 is “status or withdraw items” (FIG. 4, step 410). The flow diagram for this function is shown in FIG. 7. To status or withdraw items in the system 10, a particular user 100a selects “Show sent items” function (step 704). Sent items to be shown can either be items sent by the user doing this query or mail items sent by other users that have user 100a as a recipient.

Records of sent items corresponding to those selected by the “show sent items” function are retrieved from tag server 114 (step 706). Depending on the customer site, a large number of mail items may be transferred through system 10 every day. As the number of mail items transferred grows, so does the number of records in the mail item database 122 on the tag server 114. In order for the size of the database not to grow out of bounds and for number of records returned in response to a user query to be manageable, the database can be pruned from time to time to archive or delete old records. In the illustrative embodiment, all records older than twenty days are archived and are not retrieved in response to ordinary user queries. Once the needed records are retrieved from the database, they are sent back to the user client software 210 running on the user workstation 101. User software 210 then displays the records of the sent items according to the user preferences (step 706).

User 100a can select a different view of the shown records (step 708). For example, records of the mail items can be sorted by sender or recipient names, date, or characteristics of the “other information” fields. Alternatively, a particular filter can be applied to the records, selecting only the records that pass that filter. For example, the user may select to view only records where recipients are located at the same customer site, or records for the mail items that are still in transit and have not been received by their intended recipients. If a different sort view is selected, the user software 210 filters or sorts the records differently (step 710) and displays them for the user.

The user can then select the items that interest him from the list by double-clicking on them (step 712). User software 210 opens a new window for each selected item, displaying a full record for that mail item (step 714). This record contains a status indicator for the mail item. The status indicator is typically used to keep updated information about the mail items most recently known location. For example, it might say “In the Mail Center; about to be sorted.” By viewing the full record and status for the mail item, the user can get an idea of the item's current location, its progress through system 10 and expected delivery date and time.

If the user is satisfied with the mail item's record, or if this is the record for the mail item sent by other users, the user can then proceed to view or change other mail item's records (step 724). If the user has decided to withdraw the item, he can do so in step 716.

When user 100a elects to withdraw a mail item, system 10 checks whether the mail item to be withdrawn has already been sorted in the mail room (step 718). If the item has been sorted, withdrawing is not possible because the item may already be on the way to be delivered to the recipient. In that case, an error is returned to user 100a explaining the problem and the user is allowed to view or select another record (step 724). If, however, the mail item has not yet been sorted, it can be withdrawn from the system (step 722).

Withdrawing, in effect, constitutes the user electing for the mail item to be sent back to him instead of the original recipient. To achieve that, system 10 changes the recipient address in the item database 122 on the tag server 114 to point to the original sender. When this mail item reaches the mail center, it will be sorted in the sorting subsystem 110 (FIG. 1) along with other mail items. Upon reading the mail item's barcode, the sorting subsystem 110 retrieves the new recipient information and sorts the mail item to be delivered to the original sender. Alternatively, the sorting subsystem 110 can also print a new coversheet to affix to the mail item stating that it is to be returned to the sender or indicating the original sender as the new recipient.

Withdrawing an item might trigger a notification. System 10 checks for whether notifications need to be sent out to anyone in step 726. If any notifications are needed, they are sent in step 728. Preferences and conditions for notification are described in detail in FIGS. 8 and 9.

When notifications are sent, if needed, the user is done withdrawing the item and can return to viewing records or withdrawing other mail items (step 724) in step 712 or to performing other functions in step 730.

Yet another function available to the users 100 is changing their preferences (FIG. 4, step 412). FIG. 8 is a flow diagram of function “Change Preferences.” When the user selects to change or view preferences, user client software 210 first retrieves and displays existing user preferences in step 804.

The user can select which set of preferences to change in step 806. There are three major sets of preferences: preferences for mail items—item preferences 808, notification preferences 810, and general preferences 812.

Item preferences refer to preferences associated with creation and tracking of mail items. Preferences for creation of the mail items are retrieved and can be updated during creation of the new items, as described above (FIG. 5). Alternatively, they can be changed in this specified user function.

Mail item preferences can also refer to preferences associated with the mail item while it is in transit. For example, a user can set a “proxy” to receive his or her packages. A user 100a may for example select user 100b as his proxy. When the proxy is set, user 100b will receive any packages addressed to user 100a. User 100a can also set mail forwarding to be in effect. When mail forwarding is chosen and user 100a enters a forwarding address, any mail items sent to user 100a's address will be forwarded to the forwarding address. Other mail item preferences can be made available to users, as appropriate for each customer.

Notification preferences indicate whether and when user 100a should be notified upon an event happening in system 10. Events may be changes and updates in system 10 that can trigger notifications. A list of events includes, but is not limited to, sending a mail item, withdrawing a mail item, a mail item passing a particular point on its route, mail center sorting a mail item, hand-handling of a mail item, etc. Each user can have a set of preferences selecting events which should trigger notifications for that user. For example, user 100a can set his preferences to indicate that system 10 should notify him if any new mail items are created with user 100a as a recipient, or if any mail items are received from outside of customer site and have user 100a as a recipient. User 100a can also select to be notified only if a new mail item is created and a sender is one of a set of pre-selected senders, or if time of creation falls within one of a set of pre-selected time intervals, or if any other item information fields match user 100a notification preferences. Notifications can occur not only when mail items are created, but also when they pass any specified point in the system. For example, user 100a can select to be notified whenever a package that was sent by him is received by its intended recipient.

Errors and mishandling can also trigger notifications. For example, user 100a can select to be notified if a mail item sent by him is determined to have an invalid recipient address. In general, system 10 can be adapted to provide almost limitless flexibility in allowing users to set their notification preferences according to their wishes. Mail center personnel and administrators can set their preferences to be notified of selected events as well. While users are typically restricted to being notified of events happening to mail items in which those users are senders or recipients, mail center personnel can be notified of events happening to any items.

Whenever an event occurs, system 10 checks whether any notifications notices are needed. FIG. 9 illustrates a flow diagram for how such a check might proceed. The check may need to be performed for every user (both end user and mail personnel) in the system.

For each user 100, the system 10 retrieves user notification preferences and proceeds with the check described in FIG. 9. For example, in step 904, system 10 compares the sender of the mail item with the identity of sender described in user 100a's preferences. If there is no match, no notice is needed for user 100a and system 10 can proceed to next user.

If there is a match in step 904, system 10 checks whether there are any more notification criteria (step 906). If no additional criteria is found, a notification is to be sent. If there are additional criteria, system 10 proceeds to match recipient field (step 908). Once again, if there is no match, no notification is sent and system proceeds to steps 926 and to end 928. If there is a match, system 10 proceeds to check for additional criteria (step 910). If there are no more criteria, a notification is to be sent. If there are additional criteria, system 10 proceeds to check for time match in the similar manner (step 912). Time match can be checking for time of the mailing, time of the event that has triggered the checks, or some other processing time variable. After time, item type and other match criteria are checked in the similar manner (steps 914 through 920). At the end, if one of the criterion did not match, system 10 proceeds to step 926 and no notification is sent. If, however, all required criteria have matched, a notification is to be sent to user 100a and system proceeds to step 922.

In addition to selecting when to be notified, users can select how to be notified. Typically, notifications are sent as email messages. However, system 10 can be set up to allow for notifications to be sent out as any other electronic messages, including web messages, or even wireless phone or beeper messages. A notification is formatted according to user preferences in step 922. When notifications are formatted, they are sent to the user in step 924. When the notifications are sent, the system proceeds to check whether notifications should be sent to any other users.

In addition to mail item preferences and notification preferences, each user can change his or hers general preferences in step 812 (FIG. 8). General preferences refer to any preferences not mentioned in the previous two types. They can include, for example, general layout and look of the user interface, whether system 10 should give verbose messages and warnings, whether user wishes to be notified of system updates, and other preferences determining user's interaction with system 10.

Once user 100 selects which set of preferences to change and how, preferences are actually changed in step 814. In order to complete the change, client user software sends the updated sets of preferences to the user directory server 112, where they are stored in the user preferences database 124 (FIG. 1). After the new preferences are stored, the user can elect to change other sets of preferences (step 816) or proceed to other user functions in step 818.

Mail center user's interaction with system 10, as shown in FIG. 4B, is similar to that of a normal user (as shown in FIG. 4A). A mail center user 200 logs into the system in step 402 and opens software in step 404, as described above for the regular users. Mail center user can perform a number of functions with the mail center software 216, among which are three functions that are the same as for regular users: creating a new item in step 408 (FIG. 5), checking status of or withdrawing a sent mail item in step 410 (FIG. 7) and changing preferences in step 412 (FIG. 8). In addition to those, mail center personnel have additional functions available to them. They can change global preferences in step 414, update item record in step 416, generate a report in step 418 and, optionally, change a sortplan in step 420.

“Change Global Preferences” is an administrative function which allows a mail center person or an administrator to perform global maintenance, updates and day-to-day administration. While changing global preferences in step 414, an administrator can set defaults for all or selective users, add and delete users from the system, set preferences for package kinds and delivery types, control maximum mail item volume, do system updates and perform any other necessary administrative tasks.

If the mail center user selects “Update Record” step 416, he or she can update any existing mail item record. This update might include correcting mistakes, updating status of the mail item, or even creating a new record for either existing or new mail item. Among other times, this function is used when a mail item is sent outside the customer site. The mail center user can update when and by which carrier or courier the mail item was sent and what the outside carrier's tracking number of it is.

Mail center personnel can generate various reports in step 418 using function “Generate Reports.” Reports can include statistics about system usage, mail item transit time, types of mail item, types of functions that users perform, number of mail items sent or received by some subset of users, system throughput at any point in the system, and others. Additional types of reports can be defined according to customer preferences.

If the customer site is equipped with an automated sorted subsystem 110, as in the illustrative embodiment, mail center personnel can use system 10 to define and select sortplans using “Sortplan” function in step 420. Once a sortplan is selected, it is loaded into the sorting subsystem 110, where mail items are sorted according to that sortplan for as long as desired.

In addition to handling pure inter-office mail items, mail center personnel take care of mail items coming from and going off-site. As described above in conjunction with FIG. 5, mail items are sent off-site with a pre-selected commercial carrier if a user has selected it, or with a default mail carrier. Once the mail items are sent off-site, their off-site carrier tracking numbers are recorded as part of the mail item records in the mail item database.

FIG. 10 is a flow diagrams of steps taken by mail center personnel and system 10 when a mail items arrives from an outside location. Mail center personnel receive mail items coming from off-site in step 1004. Receiving is done in accordance with standard customer procedures. Once the mail item is received, mail center personnel or a sorting subsystem 110 determine mail item's sender and recipient information (step 1006). this determination can be made by reading mail item label or by scanning a barcode if it is of compatible type.

A check is made to determine whether recipient printed on the package is a valid recipient within system 10 (step 1008). If no valid recipient with that name is found, system 10 generates an error (step 1010) which is brought to the attention to mail center personnel and is handled by the personnel in accordance with standard customer procedures.

If the recipient is a valid recipient within system 10, system 10 checks for recipient's correct address (step 1012) in customer directory database on customer directory server 112. Even if the address printed on the mail item is not correct, the mail item will be delivered to the correct address because the correct address is retrieved from the server (step 1014). If the recipient has set a proxy user, the mail item will be delivered to that proxy; or if the recipient has set a forwarding address, the mail item will be delivered to the forwarding address.

Once the correct recipient address is retrieved, a new record is created in system 10 to correspond to the mail item. Creation of the new record can proceed through steps taken when mail center user selects “Create new item” function (FIG. 5) or a new record can be created directly in step 1016. The new record is filled with mail item information either automatically or by mail center personnel and is stored in the item database on the tag server 114.

Along with the new record, system 10 generates a new tag for the mail item. Once the tag is generated, mail center software 210 generates a new label or coversheet for the mail item (step 1018). The label or coversheet is printed and affixed to the mail item, either automatically, or by mail center personnel.

Once the mail item is equipped with the standard coversheet or label, it is sent to the recipient in the same way as a standard interoffice mail item (step 1020) and can be tracked through system 10. Accordingly, when the recipient checks for all mail items that have been sent to him, he will see the mail items coming from outside as well as those sent strictly interoffice.

Receiving a new mail item from outside and creating a new record are the kind of events that can trigger notifications. System 10 checks in step 1022 whether notifications need to be sent to anyone. If any notifications need to be sent, they are sent in step 1024. Once notifications are sent, if needed, receiving of the outside mail item is complete and mail center user can proceed to any other available functions.

The foregoing figures have shown and described a system 10 capable of tracking and managing mail items. It is to be understood that all components mentioned above are merely illustrative and can be substituted with other standard or custom components designed to fulfill similar functions. A person skilled in the art will recognize that any functions described as being performed in software can be performed in hardware or combinations of hardware and software. Computers can be single or multi-processor computers running standard or custom operating system or bare-bones software. Almost infinite variations can exist as system 10 is adapted to suit customer needs. Therefore, while the invention has been particularly shown and described above with respect to a preferred embodiment, and selected narration thereof have been mentioned, it is to be understood that this description is for purposes of illustration only and that the foregoing and other changes may be made in the invention by one skilled in the art while still remaining within the spirit and scope of the invention which is to be defined only by the appended claims.

What is claimed is:

1. A method for managing the movement of interoffice items including:
entering each item to be sent into a computer system, each said item having a tag;
the system generating and storing a record for each item;
the tag for each item being utilized at selected points in transport of the item to control said transport; and
the system querying the record for an item in response to a query concerning the item from an authorized system user to determine a response to the query and providing the response to the user.

2. A method as claimed in claim 1 including the system being operative in response to said entering step to generate a tag to be affixed to the item.

3. A method as claimed in claim 2 wherein each said tag includes an item ID which is at least one of machine readable and human readable.

4. A method as claimed in claim 3 wherein the item ID appears on the tag in bar code.

5. A method as claimed in claim 1 including updating said record for an item as the item reaches at least certain points in said transport.

6. A method as claimed in claim 6 wherein a query for an item is as to the current status thereof, the system utilizing the updated record to respond to the query.

7. A method as claimed in claim 1 wherein the query is one of a query from an item sender as to all items the sender has sent over a selected period and a query from an item recipient as to all items sent to the recipient over a selected period, the system looking at appropriate fields of item records to respond to such queries.

8. A method as claimed in claim 1 wherein senders of items include entities within the office organization and entities outside the office organization, the sender entering the item into the system for entities within the organization and a mail room person entering the item into the system for entities outside the organization.

9. A method as claimed in claim 1 wherein an electronic message is automatically sent to at least one entity when an item is entered into the system.

10. A method as claimed in claim 9 wherein the electronic message is an e-mail message.

11. A method as claimed in claim 9 wherein the electronic message is sent to an office mail room.

12. A method as claimed in claim 9 wherein each office entity may establish preferences, including that the entity is to receive an electronic message when an item is entered into the system on which the entity is a recipient, the system sending an electronic message to an entity establishing such preference each time it is the recipient of an entered item.

13. A method as claimed in claim 1 wherein each office entity can enter selected preferences into the system, the system storing the preferences and utilizing the preferences to control selected operations involving the entity.

14. A method as claimed in claim 13 wherein the preferences include selected information on the entity, the information being automatically entered into appropriate fields of a record for an item on which the entity is at least one of sender and recipient.

15. A method as claimed in claim 13 wherein the preferences include selected conditions under which the entity is to receive messages concerning an item on which the entity is one of sender and recipient, the system sending a status message to the entity when preferences conditions are satisfied.

16. A method as claimed in claim 15 wherein said selected conditions include at least one of the item reaching at least one selected point in an item transport and the nature of the item being transported.

17. A method as claimed in claim 13 wherein a user can store as preferences at least one of a proxy address and a forwarding address for at least selected mail items; and
wherein when a mail item is received which is a selected mail item with the user as recipient, the system routes the mail item to the appropriate proxy/forwarding address.

18. A method as claimed in claim 1 wherein the system has access to current addresses of office users; and
wherein, when a mail item is received with an address, the system checks the address for the user against the current address for the user and sends the item to the current address even if different from the address on the mail item.

19. A method as claimed in claim 1 wherein the office is part of an organization having at least one directory of entities within the organization; and
wherein the system utilizes said at least one directory in generating at least one of said records and said tags.

20. A method as claimed in claim 1 wherein an ordering entity at one office location can enter an order for an item to be shipped to the ordering entity by a sending entity at a second location, the order causing a tag for the item to be generated at the second location for use in sending the item to the ordering entity.

21. A method as claimed in claim 20 wherein the system generates a record for the item and updates the record as the item is shipped; and
wherein the ordering party can query the system concerning the order, the system utilizing the updated record for the item to respond to the query.

22. A method as claimed in claim 1 wherein the system sends an electronic message to at least one of an item sender and an item recipient when the item is delivered to the recipient.

23. A method as claimed in claim 1 wherein each item is to have a tag with an ID code which is both human readable and machine readable; and
wherein, if an item received at an office mail room is detected as not having an ID code in both forms, the system determines the ID code for the item and adds the ID code to the item in each missing form.

24. A method as claimed in claim 1 wherein, when an item reaches an office mail room, the tag for the item is read and any information on the tag which is not in the record for the item is added to the record.

25. A method as claimed in claim 1 wherein some of said items are to be sent to entities outside the office by a carrier having its own tags and ID codes;
wherein said entering step is performed by a sender of the item;
wherein each item in its transport reaches an office mail room; and
wherein the record for the item is utilized in conjunction with carrier software to generate a carrier tag with a carrier ID code.

26. A method as claimed in claim 25 wherein the entering step includes the sender designating the carrier to be used for the item, the entering step by the sender causing a tag to be generated for the item which tag is a carrier tag having a carrier ID code.

27. A method as claimed in claim 25 wherein the carrier tag with the carrier ID is generated at the office mail room and attached to the item.

28. A method as claimed in claim 1 including the system utilizing said records to generate reports in response to requests for such reports from selected authorized system users.

29. A method for users of a mail system to selectively track movement of items through the system including:
each user entering preferences into the system as to selected conditions under which the user is to receive electronic messages concerning an item on which the user is one of a sender and a recipient;
the system tracking movement of items through the system; and
the system sending an electronic status message to the user when one of the user preferences conditions is detected as being satisfied.

30. A method as claimed in claim 29 wherein at least one of the sender and the recipient of an item is automatically sent an electronic status message when the item is delivered.

31. A method as claimed in claim 28 wherein a mail item recipient can query the system for all items that have been sent to the recipient over a specified time interval, the system providing an electronic message to the recipient containing relevant mail items in response to such query.

32. A method as claimed in claim 28 wherein a mail item sender can query the system for all items that have been sent by the sender over a specified time interval, the system providing an electronic message to the sender containing relevant mail items in response to such query.

33. A system for managing the movement of interoffice items including:
a plurality of terminals at which a sender enters into the system at least one of an item to be sent and a query to the system;
a first mechanism operative in response to an item being entered for generating a tag to be affixed to the item;
a second mechanism operative in response to an item being entered into the system for generating and storing a record for the item;
a third mechanism operative at selected points in transport of an item in response to the tag for the item to control said transport; and
a fourth mechanism by which the system, utilizing the record for an item, obtains a response to a query from an authorized system user relating to the item and provides the response to the user.

34. A system as claimed in claim 33 wherein said first mechanism generates on each said tag an item ID which is at least one of machine readable and human readable.

35. A system as claimed in claim 34 wherein each said item ID is printed on said tag in bar code.

36. A system as claimed in claim 33 wherein said second mechanism is operative to update the record for an item as the item reaches at least certain points in said transport.

37. A system as claimed in claim 36 wherein said fourth mechanism uses the updated record for an item to respond to a query concerning status for the item

38. A system as claimed in claim 33 wherein the query is one of a query from an item sender as to all items the sender has sent over a selected period and a query from an item recipient as to all items sent to the recipient over a selected period, the fourth mechanism looking at appropriate fields of item records to respond to such queries.

39. A system as claimed in claim 33 including a fifth mechanism for selectively sending electronic messages to system users in response to the detection of selected events with respect to an item.

40. A system as claimed in claim 39 wherein said message is an e-mail message.

41. A system as claimed in claim 39 wherein the fifth mechanism sends an electronic message to at least one of the item sender and the item recipient when the item is delivered to the recipient.

42. A system as claimed in claim 33 including a sixth mechanism which facilitates the entry by system users of selected preferences, the storage of the preferences and the utilizing of the preferences to control selected operations of the system which operations involve the user.

43. A system as claimed in claim 42 wherein the preferences include selected information on the user, the second mechanism automatically entering the information into appropriate fields of a record for which the user is at least one of the sender and the recipient.

44. A system as claimed in claim 42 wherein the preferences include selected conditions under which the user is to receive messages concerning an item on which the user is one of sender and recipient, the fifth mechanism sending a status message to the entity when preferences conditions are satisfied.

45. A system as claimed in claim 44 wherein said selected conditions include at least one of the item reaching at least one selected point in an item transport and the nature of the item being transported.

46. A system as claimed in claim 33 wherein the office is part of an organization having at least one directory of entities within the organization; and
wherein at least one of said first mechanism and said second mechanism utilizes said at least one directory in generating said records and said tags respectively.

47. Apparatus which permits users of a mail system which tracks movement of items through the system to determine the movement status of selected items including:
terminals at which a user can enter into the apparatus preferences as to selected conditions under which the user is to receive electronic messages concerning an item on which the user is one of a sender and a recipient;;
a memory storing said preferences; and
a mechanism which sends an electronic status message to the user when one of the user preferences conditions is detected as being satisfied.

48. Apparatus as claimed in claim 47 wherein said mechanism automatically sends an electronic status message to at least one of the sender and the recipient when an item is delivered.

49. Apparatus as claimed in claim 47 wherein a mail item recipient can query the system for all items that have been sent to the recipient over a specified time interval; and
wherein said mechanism provides an electronic message to the recipient containing relevant mail items in response to such query.

50. Apparatus as claimed in claim 47 wherein a mail item sender can query the system for all items that have been sent by the sender over a specified time interval; and
wherein said mechanism provides an electronic message to the sender containing relevant mail items in response to such query.
